(19) United States
(12) Patent Application Publication
(10) Pub. No.: US 2014/0363680 A1
(43) Pub. Date: Dec. 11, 2014

(54) METHOD OF FORMING COLOURED TYRE PORTIONS

(71) Applicant: BRIDGESTONE CORPORATION, Chuo-ku, Tokyo (JP)

(72) Inventors: Giovanni Alessandro Pertusio, Roma (IT); Matteo Simone Almi, Milano (IT); Salvatore Cotugno, Roma (IT); Paolo Fiorenza, Roma (IT); Martina Gruarin, Roma (IT); Piero Pavoni, Roma (IT)

(73) Assignee: BRIDGESTONE CORPORATION, Chuo-ku, Tokyo (JP)

(21) Appl. No.: 14/366,997

(22) PCT Filed: Dec. 24, 2012
(86) PCT No.: PCT/IB2012/057691

§ 371 Date: Jun. 19, 2014

(30) Foreign Application Priority Data
Dec. 23, 2011 (IT) TO2011A001206

(51) Int. Cl. C09D 175/14; B60C 13/00

(52) U.S. Cl. CPC C09D 175/14; B60C 13/001
USPC 428/425.5; 428/423.1

(57) ABSTRACT

A tyre having at least one coloured portion having: —a highly impermeable barrier layer; and—a polyurethane paint on the barrier layer. The highly impermeable barrier layer is made by depositing on the part of the tyre to be coloured an aqueous dispersion which is eventually dried.

### TECHNICAL FIELD

The present invention relates to a method of forming coloured tyre portions.

### BACKGROUND ART

In recent years, there has been an increase in demand in the tyre industry for coloured tyre portions for various, not least of all, aesthetic reasons. Methods employed so far are based on adding to the tyre a coloured rubber compound formed using appropriate pigments.

The most commonly used methods employ a substantially three-layer rubber component comprising: a first connecting layer contacting the inner layers of the tyre; a second coloured layer made from the coloured compound; and a third outer cover layer which is removed prior to sale.

A drawback of this method lies in the coloured portion degrading rapidly, mainly due to chemical agents, such as antioxidants, migrating from the inner tyre layers to the coloured compound. A common practice, to slow down this degradation, is to increase the thickness of the coloured layer to slow down migration of the chemical agents. This solution, however, obviously has drawbacks in terms of heat generation and, therefore, rolling resistance.

Another more recently adopted solution is to insert between the tyre sidewall and the coloured layer a thin, highly impermeable barrier layer made from a composition designed to minimize migration of the chemical agents.

The Applicant has devised a method of forming coloured tyre portions, whereby a polymer barrier layer, formed by drying an aqueous dispersion, is deposited on the part of the tyre for colouring. This method is described in Patent Applications TO2009A000964 and TO2010A000850, which are included herein by way of reference.

This method employed water-based or UV cross-linkable paints.

Tests have shown that using these paints on a polymer barrier layer formed by drying an aqueous dispersion poses problems in terms of resistance to chemical agents and physical deterioration (cracking) of the coloured portion. Water-based paints have also been found to pose problems in terms of adhesion to the polymer barrier layer. A need is therefore felt for a method of forming coloured tyre portions, which employs a barrier layer formed from an aqueous dispersion, but without incurring the above drawbacks of the known art.

The Applicant has surprisingly discovered that this can be fully achieved using a polyurethane paint in conjunction with a polymer barrier layer formed by drying an aqueous dispersion.

### DISCLOSURE OF INVENTION

It is an object of the present invention to provide a tyre comprising at least one coloured portion; said tyre being characterized in that said coloured portion comprises:
a highly impermeable barrier layer; and
a polyurethane paint on said barrier layer.

Preferably, the highly impermeable barrier layer is made by depositing on the part of the tyre to be coloured an aqueous dispersion which is eventually dried.

Preferably, the tyre according to the present invention comprises a UV radiation protective layer on the polyurethane paint.

Preferably, the aqueous dispersion of the barrier layer comprises at least a cross-linkable polymer base, and a surfactant of molecular formula (I)

(R₁CONR₂CHR₃COO⁻)n Xⁿ⁺ (I)

where:
R₁ is an aliphatic group C₆-C₂₃
R₂ is H or an aliphatic group C₁-C₈

R₃ is H or an aliphatic or aromatic group C₁-C₈
X is a metal cation, preferably an alkaline cation, and
n is an integer of 1 to 3.

Preferably, the aliphatic group R₁ comprises a double bond.

Preferably, the aqueous dispersion of the barrier layer comprises at least a cross-linkable polymer base, and a surfactant of molecular formula (II)

([R₄R₅R₆NR₈(NR₇R₉R₁₀)n]⁽ⁿ⁺¹⁾⁺)y (n+1)X^{y-} (II)

where:
X is an atom or an anionic group
R₄, R₅ and R₆, which are the same or different, are each CₘH₂ₘ₊₁, where m is 1 to 3, or CH₂CHCH₂ or CHCHCH₃
R₇, R₉ e R₁₀, which are the same or different, are each CH₂CHCH₂ or CHCHCH₃
n is 0 or 1
y is 1, if n is 1; y is 1 or 2, if n is 0
R₈ is an aliphatic group C₁₅-C₂₂ when n is 0, and is an aliphatic group C₈-C₁₆ when n is 1
when n is 0, at least one of R₄, R₅, R₆ and R₈ comprises a double bond.

Preferably, R₇, R₈ and R₉ are CH₂CHCH₂, and, more preferably, n is 1 and R₈ is a saturated aliphatic group.

Preferably, R₈ comprises a double bond, and n is 0.

Preferably, the aqueous dispersion comprises at least one filler in the group comprising kaolin, clay, mica, feldspar, silica, graphite, bentonite, carbon black, and alumina.

Preferably, the cross-linkable polymer base comprises polymers with a Tg>0° C.

### BEST MODE FOR CARRYING OUT THE INVENTION

The following are non-limiting examples for a clearer understanding of the present invention.

### EXAMPLES

Below are described two examples (A1, A2) in accordance with the present invention and employing polyurethane paint, and four control examples (B1, B2, C1, C2) employing water-based and UV cross-linkable paints respectively.

In the invention examples and control examples, each type of paint is applied on both a barrier layer formed from an aqueous dispersion comprising anionic surfactants, and a barrier layer formed from an aqueous dispersion comprising cationic surfactants.

The two barrier layers (1 and 2) used in the examples were formed by drying respective aqueous dispersions. The dispersions were prepared by dispersing all the Table I ingredients simultaneously in 1 litre of water. The resulting aqueous dispersion was stirred mechanically for 30 minutes and then sonicated for 15 minutes.

Table I shows the compositions, in phr, of the two barrier layers formed by drying the respective aqueous dispersions.

TABLE I

| | Layer 1 | Layer 2 |
|---|---|---|
| Cl-IIR | 100 | 100 |
| CLAY | 100 | 100 |
| CARBON BLACK | 50 | 50 |
| RESIN | 10 | 10 |
| ZnO | 1.5 | 1.5 |
| SULPHUR | 2.8 | 2.8 |
| ACCELERANTS | 1.5 | 1.5 |
| SURFACTANT (a) | 2.0 | — |
| SURFACTANT (b) | — | 2.0 |

Cl-IIR stands for chlorine-butyl rubber;
SURFACTANT (a) is of molecular formula CH₃(CH₂)₇CHCH(CH₂)₇CONHCH₂COO⁻ Na⁺; and
SURFACTANT (b) is of molecular formula [(CH₃)₃N(CH₂)₈CHCH(CH₂)₇CH₃]⁺ I⁻.

The aqueous dispersion was deposited on the sidewall portion for colouring, and was dried to form the barrier layer.

In examples A, a polyurethane paint, obtained by mixing a BASF JONCRYL® 963 acrylic component and a BASF BASONAT® HA100 or BASONAT® HA300 polyisocyanate-based component, was deposited on respective barrier layers 1 and 2.

In examples B, a water-based paint, in the group known as ‘VERNICI IMC IDRO’ or ‘IMC IDROFLEX’ produced and marketed by SIVAM VERNICI SPA, was deposited on respective barrier layers 1 and 2.

In examples C, BASF LAROMER® UV cross-linkable paint was deposited on respective barrier layers 1 and 2.

The coloured portions from the above examples were tested for delamination, bending resistance, ozone resistance, adhesion, and resistance to chemical agents.

More specifically, delamination testing determines the stretch at which the paint detaches from the substrate when stress-strain tensile tested; bending resistance testing determines cracking of the paint when stressed cyclically (10 million cycles) at a set deformation; ozone resistance testing (using the VW procedure) determines cracking after exposure to ozone in 200 pphm/20% stretch/RT/48-hour conditions; adhesion testing determines detachment of the paint from the substrate by adhesive tape; and chemical resistance testing (using the RSA procedure) determines paint-flaws following immersion for a given length of time in the following chemical agents: petrol, diesel fuel, brake fluid, salt-saturated solution.

Table II shows the results from the above tests. In Table II, A1 and A2 indicate example A (polyurethane paint) formed on layers 1 and 2 respectively.

TABLE II

| | A1 | A2 | B1 | B2 | C1 | C2 |
|---|---|---|---|---|---|---|
| Delamina- | 150 | 160 | 320 | 300 | 40 | 30 |
| tion (%) | | | | | | |
| Bending | no | no | few | few | numerous | numerous |
| resistance | cracks | cracks | cracks | cracks | cracks | cracks |
| O₃ | no | no | no | no | no cracks | no cracks |
| Resistance | cracks | cracks | cracks | cracks | | |
| Adhesion | OK | OK | Not OK | Not OK | OK | OK |
| Chemical | No | No | highly | highly | flawed | flawed |
| resistance | flaws | flaws | flawed | flawed | | |

As shown by the results in Table II, examples A1 and A2 employing polyurethane paint show good results in all the tests, whereas those of examples B1, B2, C1 and C2 respectively employing water-based and UV cross-linkable paints confirm the known drawbacks.

Using polyurethane paint in conjunction with the barrier layer therefore surprisingly achieves the aims of the present invention.

1. A tyre comprising at least one coloured portion; said tyre being characterized in that said coloured portion comprises:
a highly impermeable barrier layer; and
a polyurethane paint on said barrier layer.

2. A tyre as claimed in claim 1, characterized in that said highly impermeable barrier layer is made by depositing on the part of the tyre to be coloured an aqueous dispersion which is eventually dried.

3. A tyre as claimed in claim 2, characterized by comprising a UV radiation protective layer on the polyurethane paint.

4. A tyre as claimed in claim 2, characterized in that the aqueous dispersion of the barrier layer comprises at least a cross-linkable polymer base, and a surfactant of molecular formula (I)
(R₁CONR₂CHR₃COO⁻)n Xⁿ⁺ (I)
where:
R₁ is an aliphatic group C₆-C₂₃
R₂ is H or an aliphatic group C₁-C₈
R₃ is H or an aliphatic or aromatic group C₁-C₈
X is a metal cation, and
n is an integer of 1 to 3.

5. A tyre as claimed in claim 4, characterized in that the aliphatic group R₁ comprises a double bond.

6. A tyre as claimed in claim 2, characterized in that the aqueous dispersion of the barrier layer comprises at least a cross-linkable polymer base, and a surfactant of molecular formula (II)
([R₄R₅R₆NR₈(NR₇R₉R₁₀)n]⁽ⁿ⁺¹⁾⁺y (n+1)X^{y-} (II)
where:
X is an atom or an anionic group
R₄, R₅ and R₆, which are the same or different, are each CₘH₂ₘ₊₁, where m is 1 to 3, or CH₂CHCH₂ or CHCHCH₃
R₇, R₉ e R₁₀, which are the same or different, are each CH₂CHCH₂ or CHCHCH₃
n is 0 or 1
y is 1, if n is 1; y is 1 or 2, if n is 0
R₈ is an aliphatic group C₁₅-C₂₂ when n is 0, and is an aliphatic group C₈-C₁₆ when n is 1
when n is 0, at least one of R₄, R₅, R₆ and R₈ comprises a double bond.

7. A tyre as claimed in claim 6, characterized in that R₇, R₈ and R₉ are CH₂CHCH₂.

8. A tyre as claimed in claim 6, characterized in that n is 1 and R₈ is a saturated aliphatic group.

9. A tyre as claimed in claim 6, characterized in that R₈ comprises a double bond and n is 0.

10. A tyre as claimed in claim 1, characterized in that the aqueous dispersion comprises at least one filler in the group comprising kaolin, clay, mica, feldspar, silica, graphite, bentonite, carbon black, and alumina.

11. A tyre as claimed in claim 1, characterized in that the cross-linkable polymer base comprises at least one polymer with a Tg>0° C.
